(19) United States
(12) Patent Application Publication
(10) Pub. No.: US 2013/0117224 A1
(43) Pub. Date: May 9, 2013

(54) SYSTEM, METHOD AND COMPUTER PROGRAM PRODUCT FOR CLONING A CHILD OBJECT WITH A PARENT OBJECT

(71) Applicants: James Hatton, Odessa, FL (US); Alexis Williams, Odessa, FL (US); Analia Mastrogiovanni, Tampa, FL (US); Daniel McGarry, San Francisco, CA (US)

(72) Inventors: James Hatton, Odessa, FL (US); Alexis Williams, Odessa, FL (US); Analia Mastrogiovanni, Tampa, FL (US); Daniel McGarry, San Francisco, CA (US)

(73) Assignee: salesforce.com, inc., San Francisco, CA (US)

(21) Appl. No.: 13/491,503

(22) Filed: Jun. 7, 2012

Related U.S. Application Data
(60) Provisional application No. 61/555,554, filed on Nov. 4, 2011.

(51) Int. Cl. G06F 7/00

(52) U.S. Cl. 707/610; 707/E17.005

(57) ABSTRACT

In accordance with embodiments, there are provided mechanisms and methods for cloning a child object with a parent object. These mechanisms and methods for cloning a child object with a parent object can provide improved functionality of the cloning process. Namely, the cloning of the child record with the cloning of the parent record may prevent the requirement that parent and child records be cloned via separate cloning processes.

### CLAIM OF PRIORITY

This application claims the benefit of U.S. Provisional Patent Application 61/555,554 entitled Methods and Systems for Cloning Information in One Object to Another Object in an On-Demand Services Environment,” by Hatton et al, filed Nov. 4, 2011 (Attorney Docket SFC1P184+/727PROV), the entire contents of which is incorporated herein by reference.

### COPY RIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to cloning records in a database or other system.

### BACKGROUND

The subject matter discussed in the background section should not he assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Conventionally, tools for cloning (e.g. duplicating) records in memory have been provided for creating replicas of the records. These tools have allowed users to automatically create duplicate records such that the manual re-entry of the record can be avoided. Unfortunately, the extent to which these tools allow duplication has been limited.

For example, the conventional techniques employed by these tools have prohibited the duplication of some of the features of a record. These non-cloneable features have generally included the relationships held by the record. Namely, where the record being cloned is a parent record, the child records of the parent record have conventionally been incapable of being cloned in conjunction with the cloning of the parent record.

Accordingly, it is desirable to provide techniques enabling the cloning of a child record with a parent record to improve functionality of the cloning process.

### BRIEF SUMMARY

In accordance with embodiments, there are provided mechanisms and methods for cloning a child object with a parent object. These mechanisms and methods for cloning a child object with a parent object can enable embodiments to provide improved functionality of the cloning process. Namely, the cloning of the child record with the cloning of the parent record may prevent the requirement that parent and child records be cloned via separate cloning processes.

In an embodiment and by way of example, a method for cloning a child object with a parent object is provided. In use, a request to clone a parent record is received. Additionally, at least one child record of the parent record that is to be cloned with the parent record is identified from the request. Further, the parent record is cloned with the child record, in response to the request.

While one or more implementations and techniques are described with reference to an embodiment in which cloning a child object with a parent object is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e.. ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for cloning a child object with a parent object, in accordance with an embodiment;

FIG. 2 illustrates a method for receiving a request to clone a child record with a parent record, in accordance with an embodiment;

FIGS. 3A-C illustrate exemplary graphical user interfaces (GUIs) for receiving a request to clone a child record with a parent record, in accordance with an embodiment;

FIG. 4 illustrates a block diagram of an example of an environment wherein an on-demand database service might be used; and

FIG. 5 illustrates a block diagram of an embodiment of elements of FIG. 4 and various possible interconnections between these elements.

### DETAILED DESCRIPTION

### General Overview

Systems and methods are provided for cloning a child object with a parent object.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing cloning a child object with a parent object will be described with reference to example embodiments.

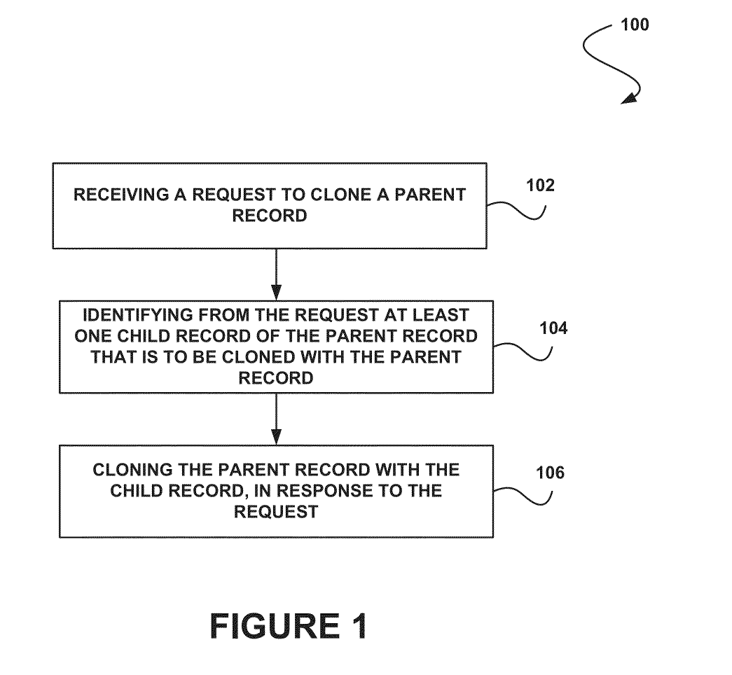

FIG. 1 illustrates a method 100 for cloning a child object with a parent object, in accordance with an embodiment. As shown in operation 102, a request to clone a parent record is received. In the context of the present description, the parent record includes any data object stored in memory having at least one child object. For example, the child record may have a child relationship with the parent record.

In one embodiment, the parent record and the child record may be records of a multi-tenant database system, such as a multi-tenant on-demand database system. The parent record may be (e.g. a row) stored in one table of the multi-tenant database system, and the child record may be (e.g. a row) stored in another table of the multi-tenant database system. Moreover, the child record may reference the parent record, or vice-versa.

In another embodiment, the parent record and child record may optionally represent different objects. Further, the parent record may represent one type of object, and the child record may represent another type of record that is capable of having a child relationship with the type of object represented by the parent object. Just by way of example, the parent record may represent a bug in an application that requires a fix, and the child record may represent a task required to be performed to complete the fix.

To this end, the request to clone the parent record may be received when it is desired to create a new instance of the parent record. With respect to an example where the parent record represents a standard business process (e.g. having a child record representing a component of the business process), the request to clone the parent record may be received when it is desired to repeat such business process (e.g. periodically, etc.).

As an option, the request may be received from a user, such as in response to the user selecting an option to clone the parent record. In one embodiment, the option may be displayed on a graphical user interface (GUI) presenting the parent record, including for example, details of the parent record. These details may be a name of the parent record, a subject of the parent record, a status of the parent record (e.g. in progress, complete, etc.), a team assigned to the parent record, child records held by the parent record, etc. In this way, the request to clone the parent record may be received from an option associated with the parent record.

Additionally, as shown in operation 104, at least one child record of the parent record that is to be cloned with the parent record is identified from the request. Thus, the request to clone the parent record may also include a request to clone the child record. It should be noted that the child record to be cloned with the parent record may optionally be only one of a plurality child records held by the parent record.

Of course, any subset, or even all, of the child records of the parent record may be indicated by the request as to be cloned with the parent record. For example, the user may specifically select to clone the child record with the parent record. In this way, any of the child records of the parent record may be selectively cloned with the parent record.

In one optional embodiment, the user-selection may be to clone child records of at least one type. Such type may be selected by the user from a plurality of types of child records held by the parent record. Accordingly, the child record identified from the request as to be cloned with the parent record may be of a type that is selected by the user. This may allow, for example, the child record to be automatically indicated in the request to clone the parent record based on the selected type. In this way, child records to be cloned with the parent record may be selected based on selection of an associated type of child records to be cloned with the parent record.

Further, as shown in operation 106, the parent record is cloned with the child record, in response to the request. In the present embodiment, cloning may refer to duplicating or other copying of the parent record with the child record. By cloning the parent record with the child record, a clone (i.e. duplicate) of the parent record having a clone of the child record may be generated.

Thus, anew parent record and a new child record having a same relationship as the existing parent record/child record may be created from the single received cloning request. This method 100 may allow an environment of a parent record to be cloned with the parent record, namely by allowing the child records depending from the parent record to be cloned in conjunction with the cloning of the parent record, such that separate requests or methods to clone the parent record and the associated child record may be avoided. It should be noted that in one optional embodiment, the method 100 may be performed by a database or other environment storing the parent record and child records (e.g. the aforementioned multi-tenant database system).

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

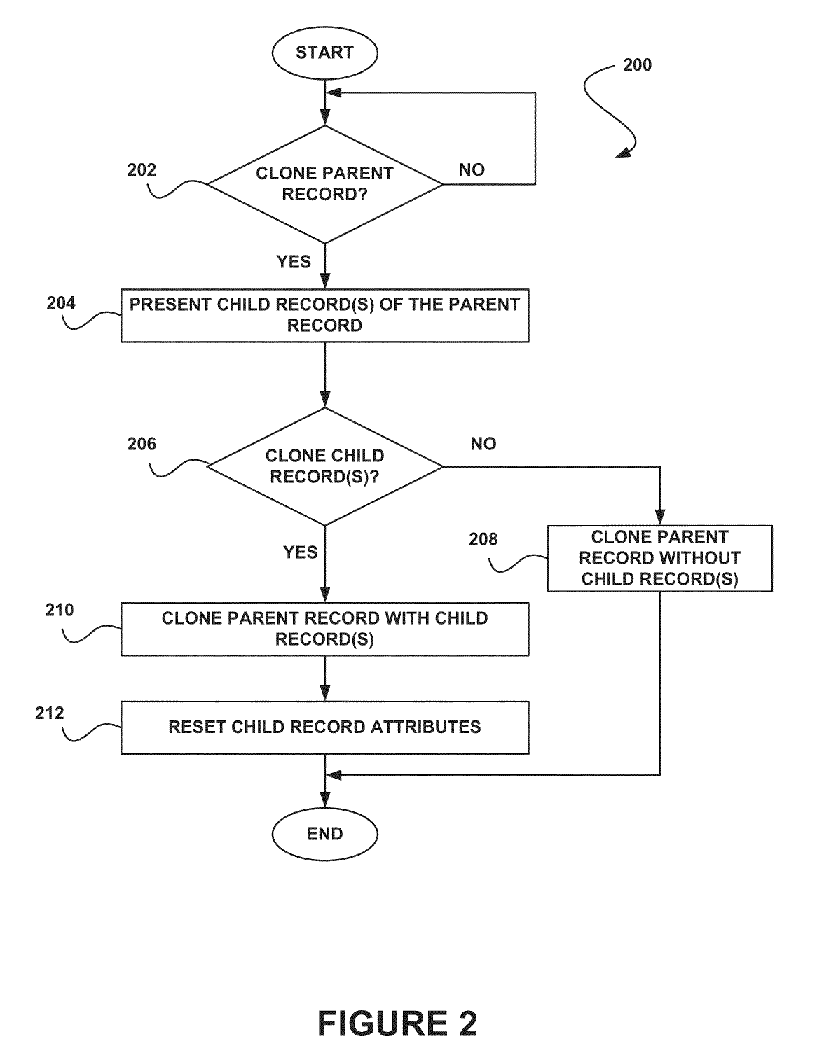

FIG. 2 illustrates a method 200 for receiving a request to clone a child record with a parent record, in accordance with an embodiment. As an option, the present method 200 may be carried out in the context of the functionality and architecture of FIG. 1. Of course, however, the method 200 may be carried out in any desired environment. It should also be noted that the aforementioned definitions may apply during the present description.

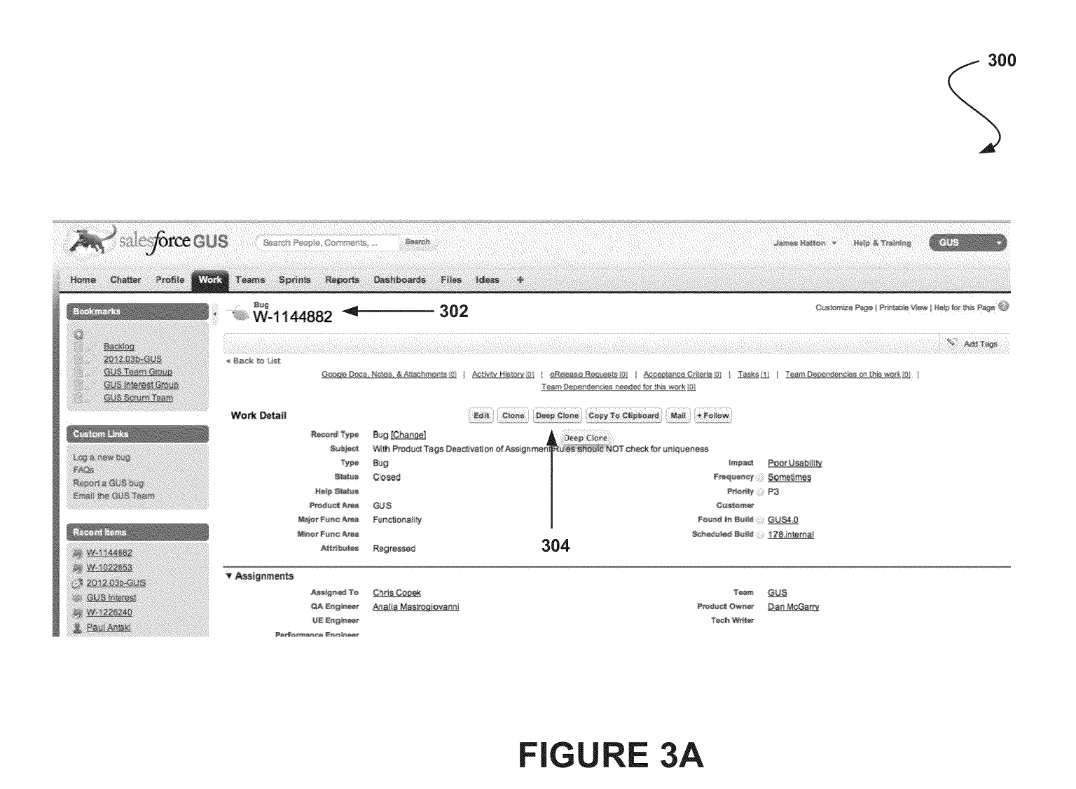

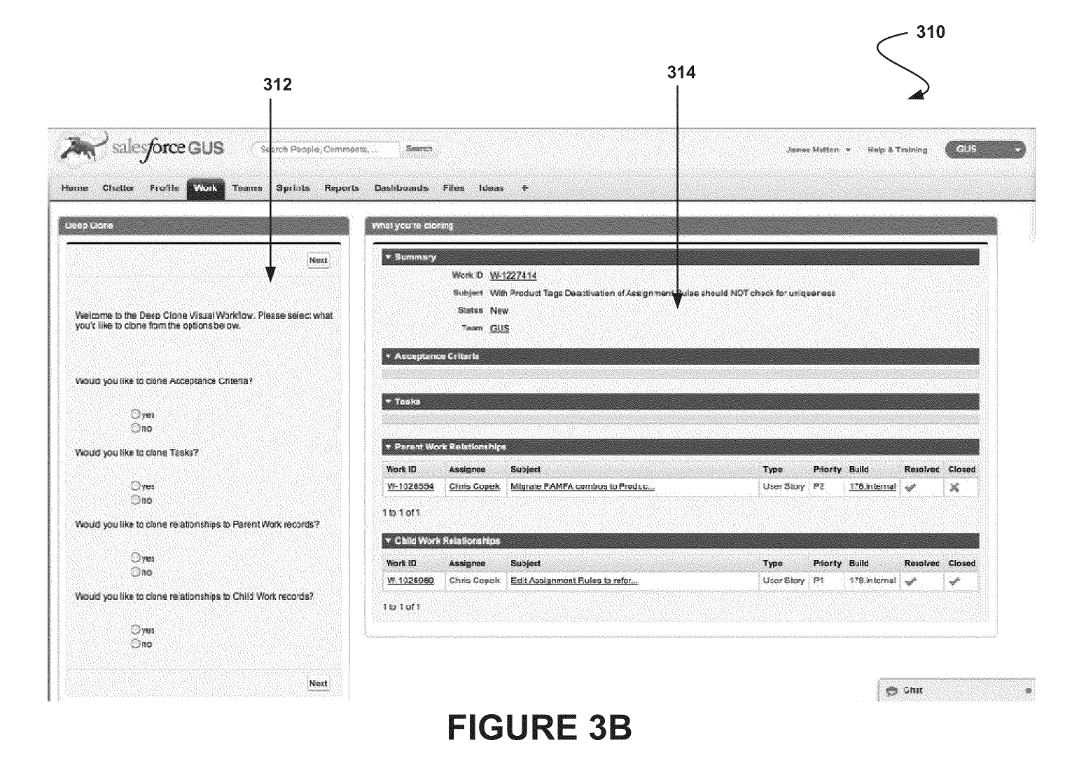

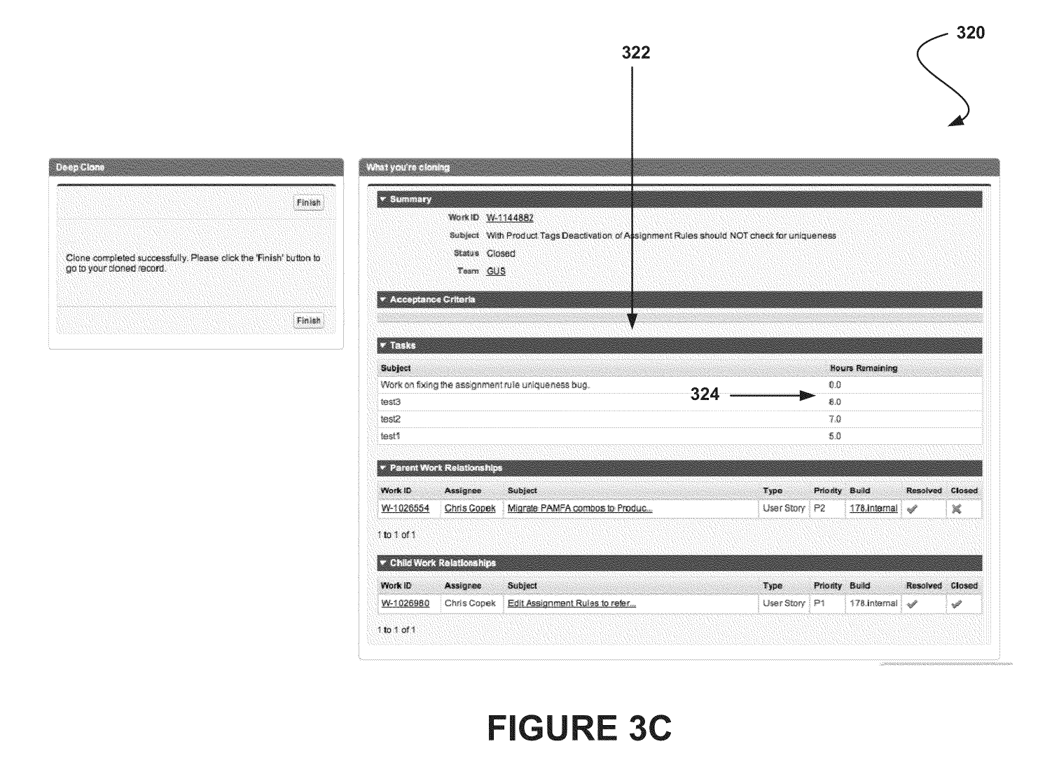

As shown in decision 202, it is determine whether a parent record is to be cloned. In the present embodiment, it may be determined that a parent record is to be cloned in response to a request being received to clone the parent record. Such a request may be made by a user selecting an option to clone the parent record. FIG. 3A illustrates an exemplary GUI (300) having an option (304) that may be used by a user to request to clone a parent record (302).

If it is determined that a parent record is not to be cloned, the method 200 continues to wait for receipt of a request to clone a parent record. However, once it is determined that a parent record is to he cloned, at least one child record of the parent record is presented. Note operation 204. In one embodiment, all child records of the parent record may be presented (e.g. displayed). In another embodiment, types of child records held by the parent record may be presented.

Furthermore, it is determined in decision 206 whether any of the child records are to be cloned with the parent record. For example, the user may select which child records are to be cloned with the parent record. In the embodiment where the child records are presented for selection thereof, the user may select individual child records to be cloned with the parent record.

In the embodiment, where types of child records held by the parent record are presented, the child records to be cloned with the parent record may be selected by type. Optionally, upon selection of a type of the child records, the child records of the selected type may be presented for indicating which child records have been selected for cloning with the parent record. FIG. 3B illustrates an exemplary GUI (310) having options (312) to select each type of child record (e.g. shown as “Acceptance Criteria,” “Tasks,” etc.), where upon selection of a type of child record, the child records (314) of that type that are held by the parent record are shown as selected for cloning with the parent record.

It should be noted that the decision of whether any of the child records are to be cloned with the parent record may be made once the user selects a final cloning option indicating that configuration of the cloning request is completed. If it is determined that no child records are to be cloned with the parent record, the parent record is cloned without cloning any child records. Note operation 208. In particular, the parent record may be duplicated and the duplicate stored in a database or other system,

However, if it is determined that one or more child records are to be cloned with the parent record, the parent record is cloned with the child records selected for cloning with the parent record, Note operation 210. For example, the parent record, selected child records, and the relationship therebetween may be duplicated and the duplicates stored in a database or other system.

Still yet, child record attributes are reset, as shown in operation 212. For example, at least one attribute of the cloned child record may be identified, Such attribute may be a field of the child record or any other portion of the child record having a particular value.

In addition, the attribute that is identified may be of a predetermined type (e.g. status, hours until completion, etc.). To this end, attribute values of the cloned child record that are of a predetermined type may be reset with a value preconfigured based on the attribute type. This may allow the value of an attribute of a cloned child record to be reset to an original value included in the at least one attribute of the child record, For example, where the value of the attribute of the original child record changes over time (e.g. is updated by users, is automatically updated, etc.), the cloned child object may optionally be set with a value of such attribute that was initially stored by the child record. FIG. 3C illustrates an exemplary GUI (320) displaying the cloned child record (322), where the values (324) of at least some of such attributes have been reset. In other exemplary embodiments, the attribute values that may be reset may be changing a “Completed” value for a status attribute to “New,” changing a “Hours Remaining” value for a time to completion attribute to a non-zero value preconfigured for that attribute, etc.

Of course, while the resetting of the child record attribute is shown as occurring after the cloning of the parent record with the child record, it should be noted that in another embodiment the resetting of the child record attribute may be performed during the cloning of the child record with the parent record. Moreover, the cloned parent record may similarly have attributes of predetermined types for which a value may be reset to a preconfigured value.

### System Overview

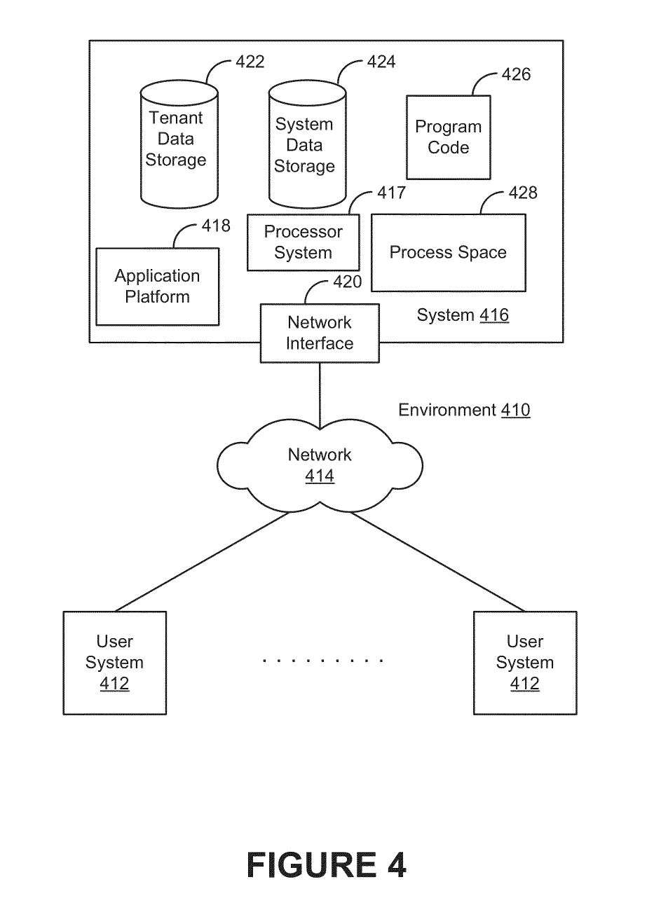

FIG. 4 illustrates a block diagram of an environment 410 wherein an on-demand database service might be used. Environment 410 may include user systems 412, network 414, system 416, processor system 417, application platform 418, network interface 420, tenant data storage 422, system data storage 424, program code 426, and process space 428. In other embodiments, environment 410 may not have all of the components listed and/or may have other elements instead of, or in addition to, those listed above.

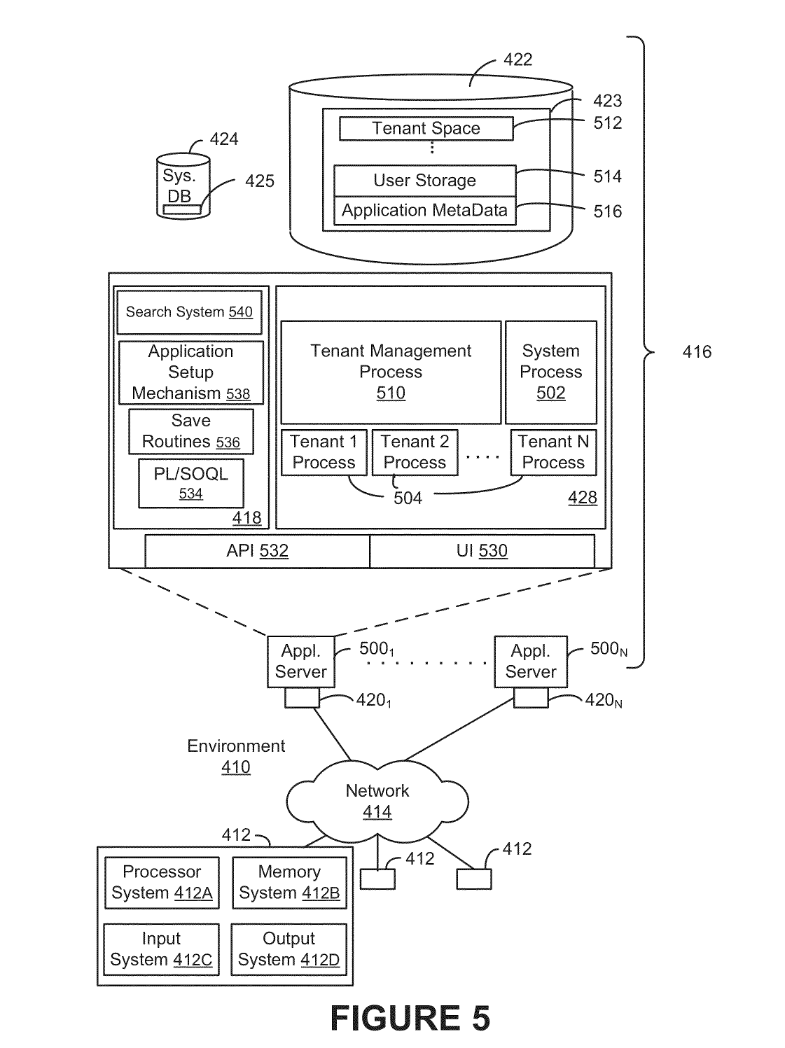

Environment 410 is an environment in which an on-demand database service exists. User system 412 may be any machine or system that is used by a user to access a database user system. For example, any of user systems 412 can be a handheld computing device, a mobile phone, a laptop computer, a work station, and/or a network of computing devices. As illustrated in FIG. 4 (and in more detail in FIG. 5) user systems 412 might interact via a network 414 with an on-demand database service, which is system 416.

An on-demand database service, such as system 416, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 416” and “system 416” will be used interchangeably herein. A database image may include one or more database objects. A relational database management system (RDMS) or the equivalent may execute storage and retrieval of information against the database object(s). Application platform 418 may be a framework that allows the applications of system 416 to run, such as the hardware and/or software, e.g., the operating system. In an embodiment, on-demand database service 416 may include an application platform 418 that enables creation, managing and executing one or more applications developed by the provider of the on-demand database service, users accessing the on-demand database service via user systems 412, or third party application developers accessing the on-demand database service via user systems 412.

The users of user systems 412 may differ in their respective capacities, and the capacity of a particular user system 412 might be entirely determined by permissions (permission levels) for the current user. For example, where a salesperson is using a particular user system 412 to interact with system 416, that user system has the capacities allotted to that salesperson. However, while an administrator is using that user system to interact with system 416, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 414 is any network or combination of networks of devices that communicate with one another. For example, network 414 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 412 might communicate with system 416 using TCP/IP and, at a higher network level, use other common Internet protocols to communicate, such as HTTP, FTP, AFS, WAP, etc. In an example where HTTP is used, user system 412 might include an HTTP client commonly referred to as a “browser” for sending and receiving HTTP messages to and from an HTTP server at system 416. Such an HTTP server might be implemented as the sole network interface between system 416 and network 414, but other techniques might be used as well or instead. In some implementations, the interface between system 416 and network 414 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 416, shown in FIG. 4, implements a web-based customer relationship management (CRM) system. For example, in one embodiment, system 416 includes application servers configured to implement and execute CRM software applications as well as provide related data, code, forms, webpages and other information to and from user systems 412 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 416 implements applications other than, or in addition to, a CRM application. For example, system 416 may provide tenant access to multiple hosted (standard and custom) applications, including a CRM application. User (or third party developer) applications, which may or may not include CRM, may be supported by the application platform 418, which manages creation, storage of the applications into one or more database objects and executing of the applications in a virtual machine in the process space of the system 416.

One arrangement for elements of system 416 is shown in FIG. 4, including a network interface 420, application platform 418, tenant data storage 422 for tenant data 423, system data storage 424 for system data 425 accessible to system 416 and possibly multiple tenants, program code 426 for implementing various functions of system 416, and a process space 428 for executing MTS system processes and tenant-specific processes, such as running applications as part of an application hosting service. Additional processes that may execute on system 416 include database indexing processes.

Several elements in the system shown in FIG. 4 include conventionat well-known elements that are explained only briefly here. For example, each user system 412 could include a desktop personal computer, workstation, laptop, PDA, ca phone, or any wireless access protocol (WAP) enabled device or any other computing device capable of interfacing directly or indirectly to the Internet or other network connection. User system 412 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 412 to access, process and view information, pages and applications available to it from system 416 over network 414. Each user system 412 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 416 or other systems or servers. For example, the user interface device can be used to access data and applications hosted by system 416, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 412 and all of its components are operator configurable using applications, such as a browser, including computer code run using a central processing unit such as an Intel Pentium® processor or the like. Similarly, system 416 (and additional instances of an MTS, where more than one is present) and all of their components might be operator configurable using application(s) including computer code to run using a central processing unit such as processor system 417, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 416 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (MID), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, javaScript, ActiveX, any other scripting language, such as VBScript, and many other programming languages as are well known may be used. (Java™ is a trademark of Sun Microsystems, Inc.).

According to one embodiment, each system 416 is configured to provide webpages, forms, applications, data and media content to user (client) systems 412 to support the access by user systems 412 as tenants of system 416. As such, system 416 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each NITS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. should also be understood that “server system” and “server” are often used interchangeably herein, Similarly, the database object described herein can be implemented as single databases, a distributed database, a collection of distributed databases, a database with redundant online or offline backups or other redundancies, etc., and might include a distributed database or storage network and associated processing intelligence.

FIG. 5 also illustrates environment 410. However, in FIG. 5 elements of system 416 and various interconnections in an embodiment are further illustrated. FIG. 5 shows that user system 412 may include processor system 412A, memory system 412B, input system 412C, and output system 412D. FIG. 5 shows network 414 and system 416. FIG. 5 also shows that system 416 may include tenant data storage 422, tenant data 423, system data storage 424, system data 425. User Interface (UI) 530. Application Program Interface (API) 532, PL/SOQL 534, save routines 536, application setup mechanism 538, applications servers 500₁-500_{N}, system process space 502, tenant process spaces 504, tenant management process space 510, tenant storage area 512, user storage 514, and application metadata 516. In other embodiments, environment 410 may not have the same elements as those listed above and/or may have other elements instead of, or in addition to, those listed above.

User system 412, network 414, system 416, tenant data storage 422, and system data storage 424 were discussed above in FIG. 4. Regarding user system 412, processor system 412A may be any combination of one or more processors. Memory system 412B may be any combination of one or more memory devices, short term, and/or long term memory. Input system 412C may be any combination of input devices, such as one or more keyboards, mice, trackball's, scanners, cameras, and/or interfaces to networks. Output system 412D may be any combination of output devices, such as one or more monitors, printers, and/or interfaces to networks. As shown by FIG. 5, system 416 may include a network interface 420 (of FIG. 4) implemented as a set of HTTP application servers 500, an application platform 418, tenant data storage 422, and system data storage 424. Also shown is system process space 502, including individual tenant process spaces 504 and a tenant management process space 510. Each application server 500 may be configured to tenant data storage 422 and the tenant data 423 therein, and system data storage 424 and the system data 425 therein to serve requests of user systems 412. The tenant data 423 might be divided into individual tenant storage areas 512, which can be either a physical arrangement and/or a logical arrangement of data, Within each tenant storage area 512, user storage 514 and application metadata 516 might be similarly allocated for each user. For example, a copy of a user's most recently used (MRU) items might be stored to user storage 514, Similarly, a copy of MRU items for an entire organization that is a tenant might be stored to tenant storage area 512. A UI 530 provides a user interface and an API 532 provides an application programmer interface to system 416 resident processes to users and/or developers at user systems 412. The tenant data and the system data may be stored in various databases, such as one or more Oracle™ databases.

Application platform 418 includes an application setup mechanism 538 that supports application developers' creation and management of applications, which may be saved as metadata into tenant data storage 422 by save routines 536 for execution by subscribers as one or more tenant process spaces 504 managed by tenant management process 510 for example. Invocations to such applications may be coded using PL/SOQL 534 that provides a programming language style interface extension to API 532. A detailed description of some PL/SOQL language embodiments is discussed in commonly owned U.S. Pat. No. 7,730,478, entitled “METHOD AND SYSTEM FOR ALLOWING ACCESS TO DEVELOPED APPLICATIONS VIA A MULTI-TENANT ON-DEMAND DATABASE SERVICE,” issued Jun. 1, 2010 to Craig Weissman, hereby incorporated in its entirety herein for all purposes. Invocations to applications may be detected by one or more system processes, which manages retrieving application metadata 516 for the subscriber making the invocation and executing the metadata as an application in a virtual machine.

Each application server 500 may be communicably coupled to database systems, e.g., having access to system data 425 and tenant data 423, via a different network connection. For example, one application server 500₁ might be coupled via the network 414 (e.g., the Internet), another application server 500_{N-1} might be coupled via a direct network link, and another application server 500_{N} might be coupled by yet a different network connection. Transfer Control Protocol and Internet Protocol (TCP/IP) are typical protocols for communicating between application servers 500 and the database system. However, it will be apparent to one skilled in the art that other transport protocols may be used to optimize the system depending on the network interconnect used.

In certain embodiments, each application server 500 is configured to handle requests for any user associated with any organization that is a tenant. Because it is desirable to be able to add and remove application servers from the server pool at any time for any reason, there is preferably no server affinity for a user and/or organization to a specific application server 500. In one embodiment, therefore, an interface system implementing a load balancing function (e.g., an F5 Big-IP load balancer) is communicably coupled between the application servers 500 and the user systems 412 to distribute requests to the application servers 500. In one embodiment, the load balancer uses a least connections algorithm to route user requests to the application servers 500. Other examples of load balancing algorithms, such as round robin and observed response time, also can be used. For example, in certain embodiments, three consecutive requests from the same user could hit three different application servers 500, and three requests from different users could hit the same application server 500. In this manner, system 416 is multi-tenant, wherein system 416 handles storage of, and access to, different objects, data and applications across disparate users and organizations.

As an example of storage, one tenant might be a company that employs a sales force where each salesperson uses system 416 to manage their sales process. Thus, a user might maintain contact data, leads data, customer follow-up data, performance data, goals and progress data, etc., all applicable to that user's personal sales process (e.g., in tenant data storage 422). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 416 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time. and backup are additional functions that may be implemented in the MTS. In addition to user-specific data and tenant specific data, system 416 might also maintain system level data usable by multiple tenants or other data. Such system level data might include industry reports, news, postings, and the like that are sharable among tenants.

In certain embodiments, user systems 412 (which may be client systems) communicate with application servers 500 to request and update system-level and tenant-level data from system 416 that may require sending one or more queries to tenant data storage 422 and/or system data storage 424. System 416 (e.g., an application server 500 in system 416) automatically generates one or more SQL statements (e.g., one or more SQL queries) that are designed to access the desired information. System data storage 424 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another, table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, entitled “CUSTOM ENTITIES AND FIELDS IN A MULTI-TENANT DATABASE SYSTEM”, issued Aug. 27, 2010 to Craig Weissman, and hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product, comprising a non-transitory computer usable medium having a computer readable program code embodied therein, the computer readable program code adapted to be executed to implement a method, the method comprising:
receiving a request to clone a parent record;
identifying from the request at least one child record of the parent record that is to be cloned with the parent record; and
cloning the parent record with the child record, in response to the request.

2. The computer program product of claim 1, wherein the request is received from a user.

3. The computer program product of claim 2, wherein the request is received in response to the user selecting an option to clone the parent record.

4. The computer program product of claim 3, wherein the option is displayed on a graphical user interface presenting the parent record.

5. The computer program product of claim 1, wherein the at least one child record has a child relationship with the parent record.

6. The computer program product of claim 1, wherein the at least one child record and the parent record are records of a multi-tenant on-demand database system.

7. The computer program product of claim 1, further comprising receiving a user-selection to clone with the parent record child records of at least one type.

8. The computer program product of claim 7, wherein the at least one type is user-selected from plurality of types of child records held by the parent record.

9. The computer program product of claim 7, wherein the at least one child record is of the at least one type that is user-selected.

10. The computer program product of claim 7, the at least one child record is automatically indicated in the request to clone the parent record based on the selected type.

11. The computer program product of claim 1, further comprising identifying at least one attribute of the at least one child record.

12. The computer program product of claim 11, wherein the at least one attribute is a field of the at least one child record.

13. The computer program product of claim 11, wherein the at least one attribute is of a predetermined type.

14. The computer program product of claim 13, wherein the predetermined type includes a status.

15. The computer program product of claim 13, wherein the predetermined type includes hours until completion.

16. The computer program product of claim 11, further comprising automatically resetting a value of the at least one attribute.

17. The computer program product of claim 16, wherein the value is reset to an original value included in the at least one attribute of the child record.

18. The computer program product of claim 1, wherein the parent record is cloned with the child record to generate a clone of the parent record having a clone of the child record.

19. A method, comprising:
receiving a request to clone a parent record;
identifying from the request at least one child record of the parent record that is to be cloned with the parent record; and
cloning the parent record with the child record, in response to the request, utilizing a processor.

20. An apparatus, comprising:
a processor for:
receiving a request to clone a parent record;
identifying from the request at least one child record of the parent record that is to be cloned with the parent record; and
cloning the parent record with the child record, in response to the request.

21. A method for transmitting code, comprising:
transmitting code for receiving a request to done a parent record;
transmitting code for identifying from the request at least one child record of the parent record that is to be cloned with the parent record; and
transmitting code for cloning the parent record with the child record, in response to the request.
